(19) United States
(12) Patent Application Publication
(10) Pub. No.: US 2012/0237118 A1
(43) Pub. Date: Sep. 20, 2012

(54) IMAGE PROCESSING DEVICE, IMAGE PROCESSING METHOD, AND IMAGE PROCESSING PROGRAM

(75) Inventors: Tadashi HYUGA, Hirakata-shi (JP); Masashi KURITA, Nara-shi (JP); Hatsumi AOI, Kyotanabe-shi (JP)

(73) Assignee: OMRON CORPORATION, Kyoto-shi (JP)

(21) Appl. No.: 13/295,557

(22) Filed: Nov. 14, 2011

(30) Foreign Application Priority Data
Mar. 15, 2011 (JP) 2011-057262

(51) Int. Cl. G06K 9/66

(52) U.S. Cl. 382/161

(57) ABSTRACT

An image processing method is used to detect a letter by using a classifier generated through statistical learning of handling a sample image of a fixed size as supervised data, and includes the following steps. A conversion step acquires a converted image by geometrically converting a target image containing a letter to be detected such that the target image has a predetermined ratio defining an aspect ratio. A search step searches the converted image for one or more letter candidates each including a region of a possible letter by using the classifier. An integration step applies clustering to the letter candidates, integrating the letter candidates, and eliminates the letter candidate having low reliability A circumscribing step cuts a letter out of the letter candidate that has been integrated and has not been eliminated, and generates a rectangle circumscribing the letter.

### CROSS REFERENCE TO RELATED APPLICATIONS

This application claims priority based on 35 USC 119 from prior Japanese Patent Application No. 2011-057262 filed on Mar. 15, 2011, entitled “IMAGE PROCESSING DEVICE, IMAGE PROCESSING METHOD, AND IMAGE PROCESSING PROGRAM”, the entire contents of which are incorporated herein by reference.

### BACKGROUND OF THE INVENTION

1. Technical Field

The present disclosure relates to an image processing device, an image processing method, and an image processing program for detecting a letter or the like printed on a commercial product sample or some other object In particular, the present disclosure relates to an image processing device, an image processing method, and an image processing program for detecting a letter by using a classifier generated through statistical learning of handling sample images of a fixed size as supervised data.

2. Related Art

As a technique for detecting letters utilizing a statistical learning system, there has been introduced an image processing method and device (refer to Japanese Patent No. 3965983, for example). This method and device enables accurate recognition of individual letters, which are difficult to be extracted correctly by a binary process or some other typical process.

Unfortunately, the above technique needs performing recognition processes for respective combinations of elements, rather than performing a recognition process after extracting letters. As a result, this technique involves a long process time.

Furthermore, there has been proposed a system and method for detecting a letter in a real-world color image by using a cascade classifier formed through boosting learning (refer to U.S. Pat. No. 7,817,855, for example).

Disadvantageously, the above technique described in U.S. Pat. No. 7,817,855 needs a process for detecting a letter string by using the classifier, and then, dividing the detected letter string into individual letters. Accordingly, this technique also involves a long process time.

Moreover, there has been proposed a letter image separation device, method, and program, and a recording medium for storing the program (refer to Japanese Unexamined Patent Publication 2006-023983, for example). The technique described in this reference is configured to separate letter regions from other regions in each small region by using an easily learnable statistical system, and to integrate results therefrom, thereby acquiring a letter region extraction result with high reliability

However, this technique needs to perform determination and result integration processes for every pixel. Therefore, this technique also involves a long process time.

Such a letter detection technique employs a statistical learning system, and extracts letters by using a classifier generated by image samples of a fixed size (referred to as “supervised data”) and a learning framework In this technique, if supervised data contains an extremely vertically elongated letter, then a vertically long non-letter pattern tends to be erroneously extracted from an image as a letter.

For example, if supervised data contains only letters of a normal aspect ratio such as “1” or “8” shown in FIG. 15A, then these letters can be detected without causing any problems. In contrast, if supervised data also contains vertically long letters such as “1” or “8” shown in FIG. 15B, then the erroneous detection is more likely to occur, because the differences in feature between letters and vertically long non-letter patterns are made less significant

### SUMMARY

In consideration of the above-described disadvantage, an object of an embodiment of the invention is to provide an image processing device, method, and program, that makes it possible to accurately recognize letters and the like printed on a commercial product sample or some other object, by minimizing an influence of a large number of letters having aspect ratios different from a normal aspect ratio in a target image to be recognized.

One aspect of the invention is an image processing device for detecting a letter by using a classifier generated through statistical learning of handling a sample image of a fixed size as supervised data, the image processing device including: a conversion unit acquiring a converted image by geometrically converting a target image containing a letter to be detected such that the target image has a predetermined ratio defining an aspect ratio; a search unit searching the converted image for one or more letter candidates each including a region of a possible letter by using the classifier, an integration unit applying clustering to the letter candidates searched for by the search unit, integrating the letter candidates, and eliminating the letter candidate having low reliability; and a circumscribing unit cutting a letter out of the letter candidate that has been integrated and has not been eliminated by the integration unit, and generating a rectangle circumscribing the letter.

The classifier may be, for example, a cascade classifier which is a single strong classifier formed by combining multiple weak classifiers so as to constitute a cascade structure. However, the invention is not limited thereto.

The image processing device thus configured can accurately recognize letters or the like printed on a commercial product sample or some other object, by minimizing an influence of many letters each having an aspect ratio different from a normal ratio and contained in supervised data.

The image processing device may further include a setting input unit receiving an external setting input of the predetermined ratio defining the aspect ratio of the target image by the conversion unit.

The image processing device may further include a mark detection unit extracting a region corresponding to a mark from a non-letter region circumscribed in a rectangle generated by the circumscribing unit.

The image processing device may further include a letter recognition unit recognizing the letter circumscribed in the rectangle generated by the circumscribing unit

Another aspect of the invention is an image processing device for detecting a letter by using a classifier generated through statistical learning of handling a sample image of a fixed size as supervised data, the image processing device including: a conversion unit geometrically converting a target image containing a letter to be detected such that a parameter indicating a geometrical feature of the target image has a predetermined value, so as to obtain a converted image; and a search unit searching the converted image acquired by the conversion unit for one or more letter candidates each including a region of a possible letter by using the classifier.

In the above-described image processing device, the parameter may include an aspect ratio of the target image.

The above-described image processing device may further include an integration unit applying clustering to the letter candidates searched for by the search unit, integrating the letter candidates, and eliminating the letter candidate having low reliability.

The above-described image processing device may further include a circumscribing unit cutting a letter out of the letter candidate that has been integrated and has not been eliminated by the integration unit, and generating a rectangle circumscribing the letter.

Still another aspect of the invention is an image processing method for detecting a letter by using a classifier generated through statistical learning of handling a sample image of a fixed size as supervised data, the image processing method including: a conversion step of acquiring a converted image by geometrically converting a target image containing a letter to be detected such that the target image has a predetermined ratio defining an aspect ratio; a search step of searching the converted image for one or more letter candidates each including a region of a possible letter by using the classifier, an integration step of applying clustering to the letter candidates searched for in the search step, integrating the letter candidates, and eliminating the letter candidate having low reliability; and a circumscribing step of cutting a letter out of the letter candidate that has been integrated and has not been eliminated in the integration step, and generating a rectangle circumscribing the letter.

The image processing method thus configured makes it possible to accurately recognize letters or the like printed on a commercial product sample or some other object, by minimizing an influence of many letters each having an aspect ratio different from a normal ratio and contained in supervised data.

Yet another aspect of the invention is an image processing program allowing a computer to execute the image processing method described above.

The above-described image processing device and method according to the aspects make it possible to accurately recognize letters or the like printed on a commercial product sample or some other object, by minimizing an influence of many letters each having an aspect ratio different from a normal ratio and contained in a recognition target image.

Simply with a computing environment enabling the execution of the image processing program, the image processing method can be implemented in any place. In addition, if this image processing program is made executable in a general purpose computer, then it is unnecessary to prepare a computing environment dedicated to implement the image processing method This increases the usage of the image processing program.

### BRIEF DESCRIPTION OF THE DRAWINGS

FIG. 1 is a perspective view of an exemplary arrangement of an image processing device according to an embodiment of the invention;

FIG. 2 is a view showing an exemplary structure of an image processing device body in the image processing device according to the embodiment of the invention;

FIG. 3 is a view showing an exemplary functional structure of a CPU and its peripheral units shown in FIG. 2;

FIG. 4 is a flowchart showing a general process of a letter detection algorithm to be executed by the CPU;

FIGS. 5A to 5D are exemplary views showing resultant images in processes in steps S104, S105, S107, and S108, respectively in the flowchart shown in FIG. 4;

FIGS. 6A and 6B are exemplary views showing images before and after the process in step S103 is executed, respectively;

FIG. 7 is an exemplary view showing an image used for explaining the process in step S104;

FIG. 8 is a schematic view showing a flow of a determination process which is executed by a cascade classifier used in the process in step S104;

FIG. 9A is an exemplary view for explaining clustering in the intersection determination, and FIG. 9B is an exemplary view for explaining the elimination of rectangles upon intersection determination;

FIGS. 10A, 10B and 10C are exemplary views for explaining the adjustment of overlapping between rectangles, the cutout of an image in each rectangle, and the binary process using a differential histogram, respectively;

FIGS. 11A, 11B and 11C are exemplary views for explaining a labeling process, the elimination of noise on each rectangle frame, and a fitting process, respectively;

FIG. 12 is an exemplary view for explaining the estimation of mark search regions;

FIG. 13 is an exemplary view for explaining the detection of a mark by using binary and projection processes;

FIG. 14 is an exemplary view showing a user interface screen displayed on the monitor, when a user enters a compressed aspect ratio of a target image to an image compression unit of the image processing device; and

FIGS. 15A and 15B are exemplary views showing supervised data only containing letters having a normal aspect ratio, and supervised data containing normal and vertically long letters.

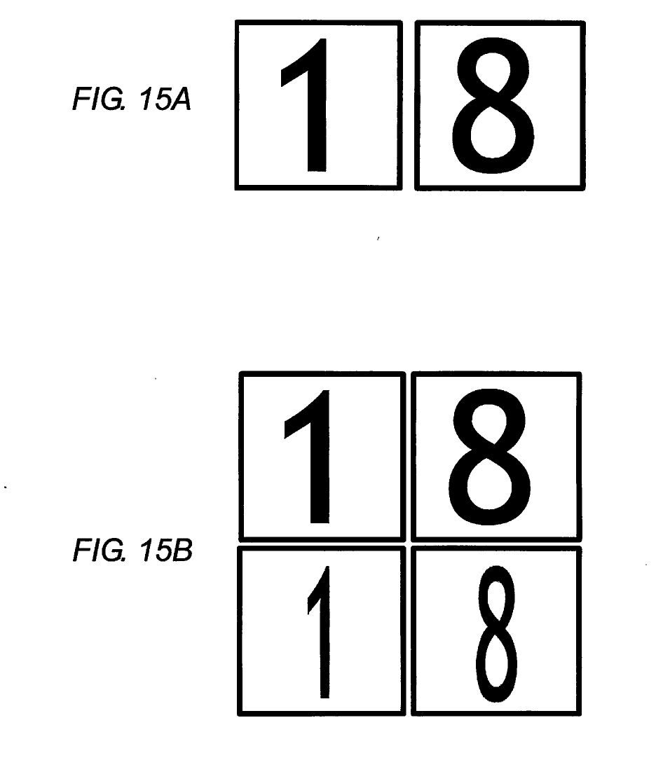

### DETAILED DESCRIPTION OF EMBODIMENTS

A description will be given below of an image processing device, an image processing method, and an image processing program according to an embodiment of the invention, with reference to accompanying drawings.

<Arrangement of Image Processing Device 100>

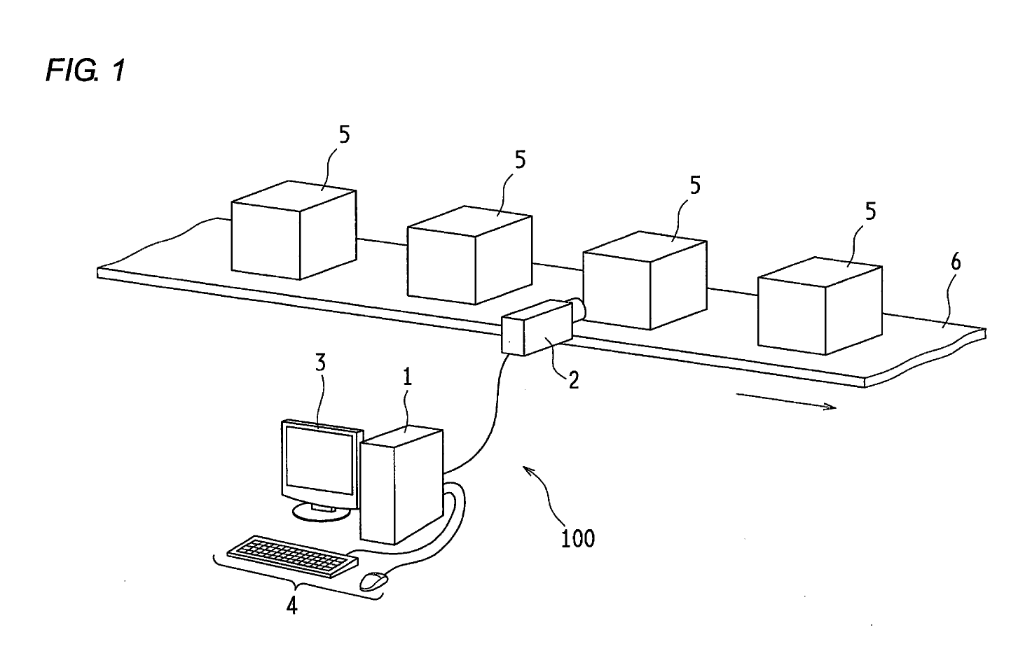

First, a description will be given of an exemplary arrangement of an image processing device 100 according to this embodiment of the invention, with reference to FIG. 1. FIG. 1 is a perspective view showing an exemplary arrangement of the image processing device 100. This image processing device 100 is installed, for example, in a factory for manufacturing products 5. In addition, this device is configured to apply an image process to an image including a letter string composed of multiple letters, characters, or a combination thereof, such as three alphabetical letters, formed on a surface of each product 5, thereby recognizing the letters, characters, or combination thereof in the letter string. In this embodiment, the surface of the product 5 faces a CCD camera 2. In addition, the product 5 corresponds to an “object” in claims.

In this embodiment, a description will be given in the case where letter strings are formed on the surfaces of the individual products 5. However, the invention is not limited to this embodiment Alternatively, letter strings may be formed on the surfaces of any objects, including agricultural products such as fruits or vegetables, marine products such as fishes or shellfishes, electronic components such as integrated circuits (ICs), resistors, or capacitors, raw materials, and product assemblies.

Moreover, in the description of the embodiment, letter strings are formed on flat surfaces. However, such letter strings may be formed on curved, uneven, or any other shaped surfaces.

Referring to FIG. 1, the image processing device 100 includes an image processing device body 1, the COD camera 2, a monitor 3, and an input device 4. In this embodiment, this device is placed near a conveyer 6 for transferring the products 5. In addition, it is preferable that the CCD camera 2 of the image processing device 100 be placed near the conveyer 6 so as to generate an image containing a letter string formed on the surface of each product 5. Meanwhile, the image processing device body 1, the monitor 3, and the input device 4 do not need to be placed near the conveyer 6. More preferably, the image processing device body 1, monitor 3, and input device 4 are arranged in a dean place with less dust and at ordinary temperatures, such as a room of an operator for the image processing device 100.

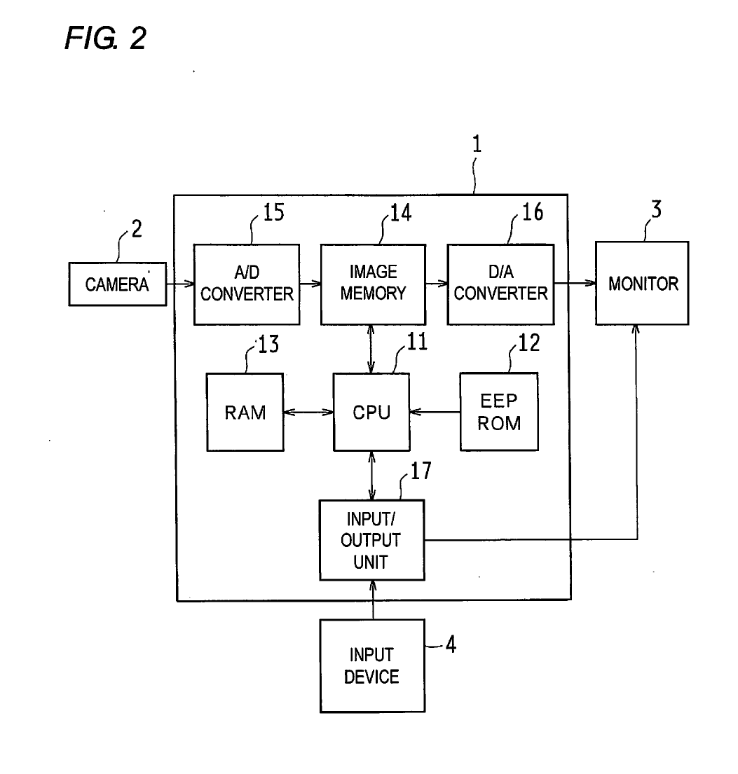

The image processing device body 1 controls operations of the entire image processing device 100. A specific structure thereof will be described later with reference to FIG. 2.

The CCD (charge coupled device) camera (also referred to simply as “camera” hereinafter) 2 sequentially images the letter strings formed on the surfaces of the individual products 5 that are being transferred on the conveyer 6, so as to generate images thereof. This camera 2 is provided with a lens facing the products 5 on the conveyer 6. Information on images generated by the camera 2 is sequentially outputted to the image processing device body 1.

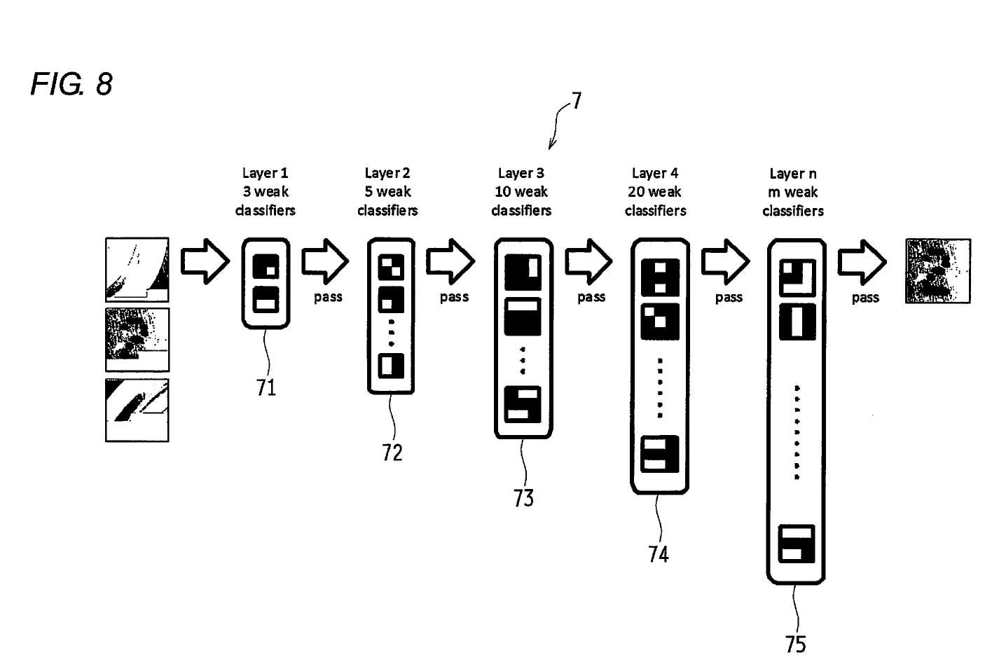

The monitor 3 displays various images so as to be viewable externally, in accordance with instructions from the image processing device body 1. This monitor 3 may be provided with, for example, a liquid crystal display (LCD). In this embodiment, the monitor 3 corresponds to an Image display unit” recited in claims. For example, the monitor 3 displays the information on the images generated by the camera 2, on result display screens 800 and 810, as will be described later with reference to FIG. 8, and various guidance notices.

The input device 4 receives operations of an operator and the like, and includes a keyboard and a mouse. In this embodiment, the input device 4 corresponds to an “operation receiving unit” in claims. Upon receiving information on input operations from an operator, the input device 4 outputs the information to the image processing device body 1.

<Structure of Image Processing Device Body 1>

Next, a structure of the image processing device body 1 will be described with reference to FIG. 2. FIG. 2 shows an exemplary structure of the image processing device body 1 according to this embodiment of the invention. Referring to FIG. 2, the image processing device body 1 includes a CPU 11, an EEPROM 12, a RAM 13, an image memory 14, an A/D converter 15, a D/A converter 16, and an input/output unit 17.

The CPU (central processing unit) 11 controls operations of the entire image processing device body 1, and performs various processes by executing control programs stored in a read only memory (ROM) (not shown), the EEPROM 12, or the like. Herein, at least one of the control programs corresponds to the image processing program of the invention, and the CPU 11 corresponds to a “computer” recited in claims.

The EEPROM (electrically erasable programmable read-only memory) 12 is a rewritable nonvolatile memory, and stores various parameter values and the like to be used in an image process of recognizing letters in image information generated by the camera 2. The RAM 13 (random access memory) temporally stores data inputted by the input device 4 as the results of processes performed by the CPU 11.

The A/D converter 15 receives analog image signals from the camera 2, and coverts these signals into digital image information. The converted grayscale image information is stored in the image memory 14. In this embodiment, the grayscale image information includes, for example, 256 gradation values (also referred to as gradation information) indicating gray scales of pixels in correspondence with luminance ranges from white to black. That is, the grayscale image information is gradation information corresponding to respective pixels.

The image memory 14 stores various pieces of image information. Specifically, this memory stores information such as image information received from the A/D converter 15, as well as image information to which a binary process is applied in an image process of letter recognition (also referred to as “binary image” hereinafter). The D/A converter 16 converts the image information stored in the image memory 14 into analog image display signals. The converted analog signals are outputted to the monitor 3.

The input/output unit 17 functions as interfaces between the CPU 11 and the input device 4 and between the CPU 11 and the monitor 3 by performing input/output processes therebetween.

<Functional Structure of CPU 11>

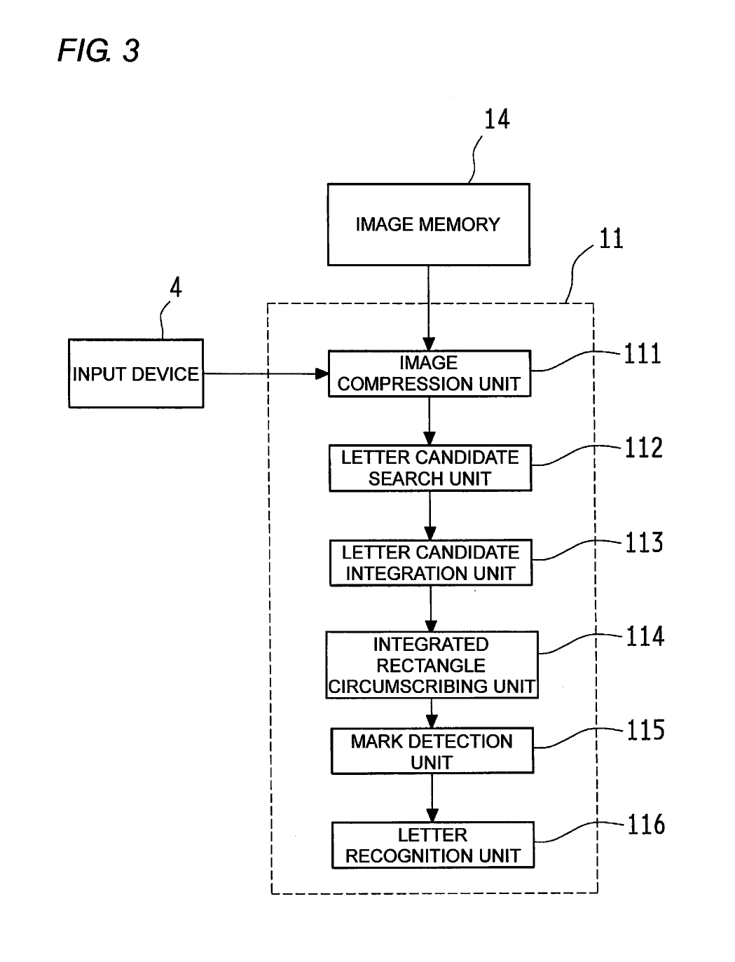

Next, a structure of the CPU 11 and the like will be described with reference to FIG. 3. FIG. 3 shows an exemplary functional structure of the CPU 11 and the like shown in FIG. 2. The CPU 11 reads a control program (or the image processing program of the invention) from the ROM (not shown), and executes the program, thereby functioning as an image compression unit 111, a letter candidate search unit 112, a letter candidate integration unit 113, an integrated rectangle circumscribing unit 114, a mark detection unit 115, a letter recognition unit 116, and the like.

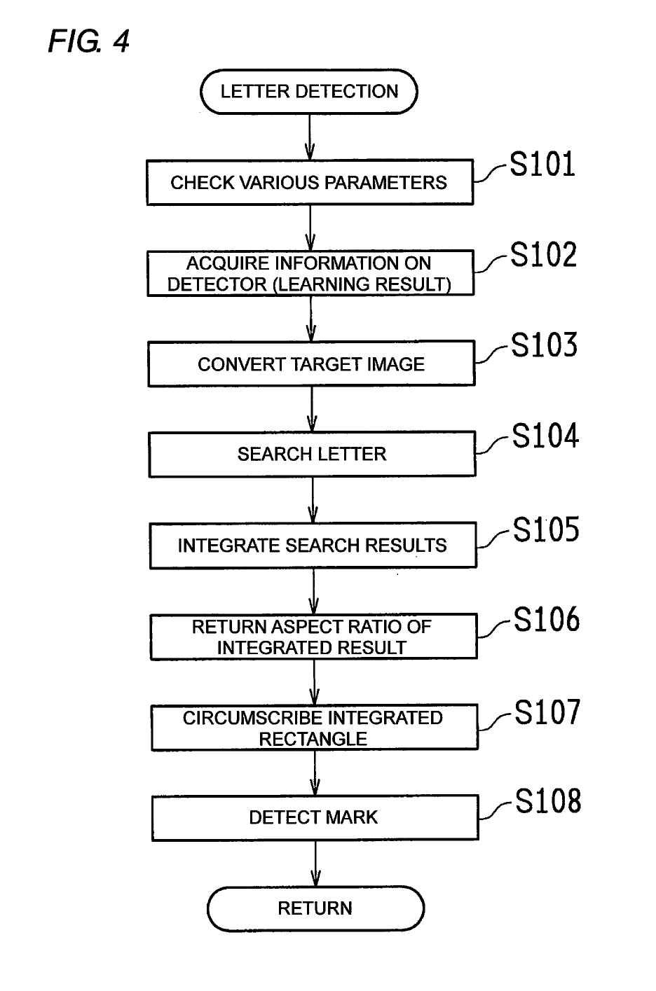

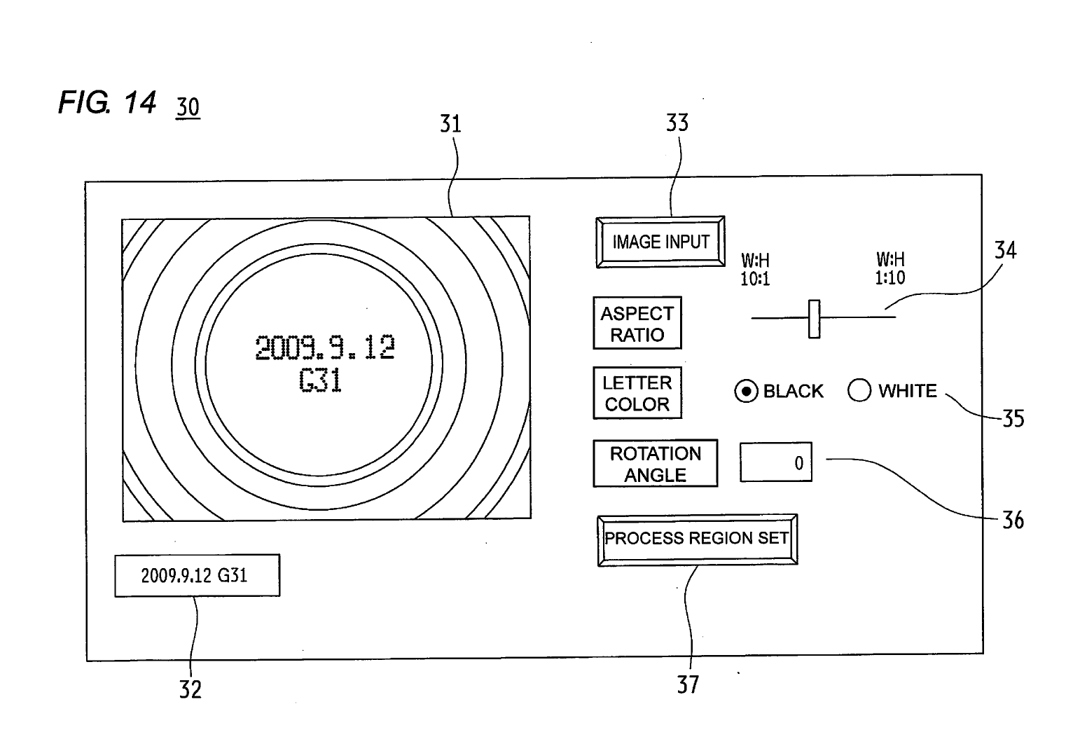

The image compression unit 111 reads a target image containing a letter to be detected and stored in the image memory 14, and obtains a compressed image by compressing the target image so that the target image has a predetermined aspect ratio. Details of this compressing process will be described later with reference to step S103 of FIG. 4. It should be noted that the predetermined aspect ratio of the target image may be preset and stored in the EEPROM 12 or the like, or may be set or changed by receiving an external setting operation, such as a user's operation, through the input device 4. Details of this setting process will be described later with reference to FIG. 14.

The letter candidate search unit 112 searches for at least one letter candidate in the compressed image generated by the image compression unit 111. The letter candidate is defined by a region that possibly contains a letter. Details of this search process will be described later with reference to step S104 of FIG. 4.

The letter candidate integration unit 113 integrates the letter candidates searched for by the letter candidate search unit 112 by performing a clustering process. In addition, the unit 113 eliminates lowly reliable letter candidates. Details of this process will be described later with reference to step S105 of FIG. 4.

The integrated rectangle circumscribing unit 114 cuts letters out of the letter candidates which have been integrated and have not been eliminated by the letter candidate integration unit 113. Following this, the unit 114 generates rectangles circumscribing the corresponding cutout letters. Details of this process will be described later with reference to step S107 of FIG. 4.

The mark detection unit 115 extracts, from regions other than the letters around each of which a rectangle was circumscribed by the integrated rectangle circumscribing unit 114, regions corresponding to marks. Details of this process will be described later with reference to step S108 of FIG. 4.

The letter recognition unit 116 recognizes the letter in each rectangle circumscribed by the integrated rectangle circumscribing unit 114. The unit 116 may employ a known letter recognition technique.

<Process Flow of Letter Detection Algorithm>

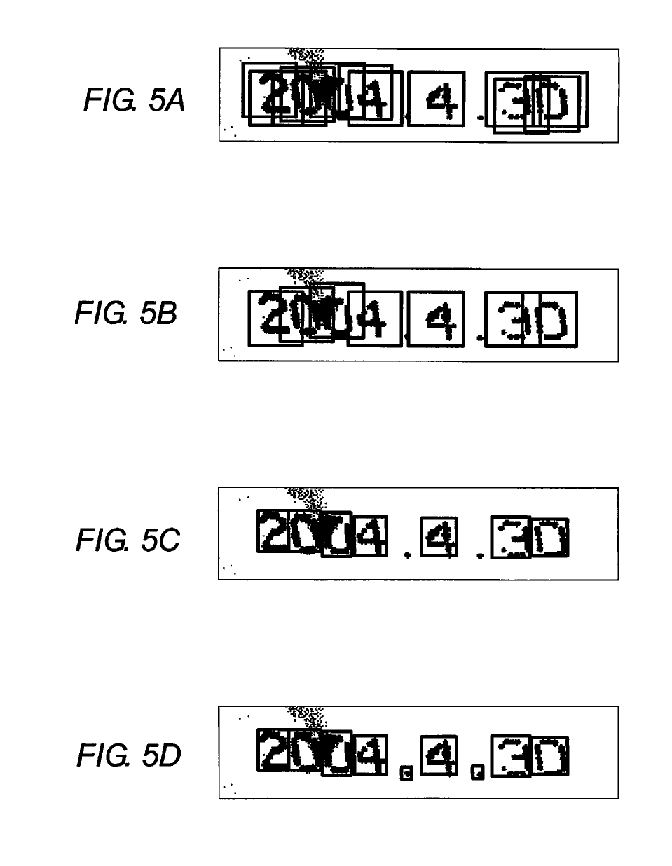

FIG. 4 is a flowchart showing a general process of a letter detection algorithm to be executed by the CPU 11. For example, this letter detection algorithm may be registered in a software library or the like as a function. FIGS. 5A to 5D are views of exemplary images resulted from processes in steps S104, S105, S107, and S108, respectively of the flowchart of FIG. 4.

Before executing this letter detection algorithm, assume that an image containing a letter to be detected is generated by the camera 2 (see FIGS. 1 and 2) and stored in the image memory 14. After the letter detection algorithm is executed, a known letter recognition technique will be applied.

Step S101: Checking Various Parameters

First, the CPU 11 checks whether or not all parameter values given by arguments fall within applicable ranges for use. The CPU sets new parameters in accordance with the values of the respective arguments if all the parameters fall within these ranges. Specifically, the CPU conforms and sets a size of an image and a size of a process region in this order.

Step S102: Acquiring Information on Detector (Learning Result)

Next, the CPU 11 acquires information on a detector (a learning result).

Step S103: Converting Target Image

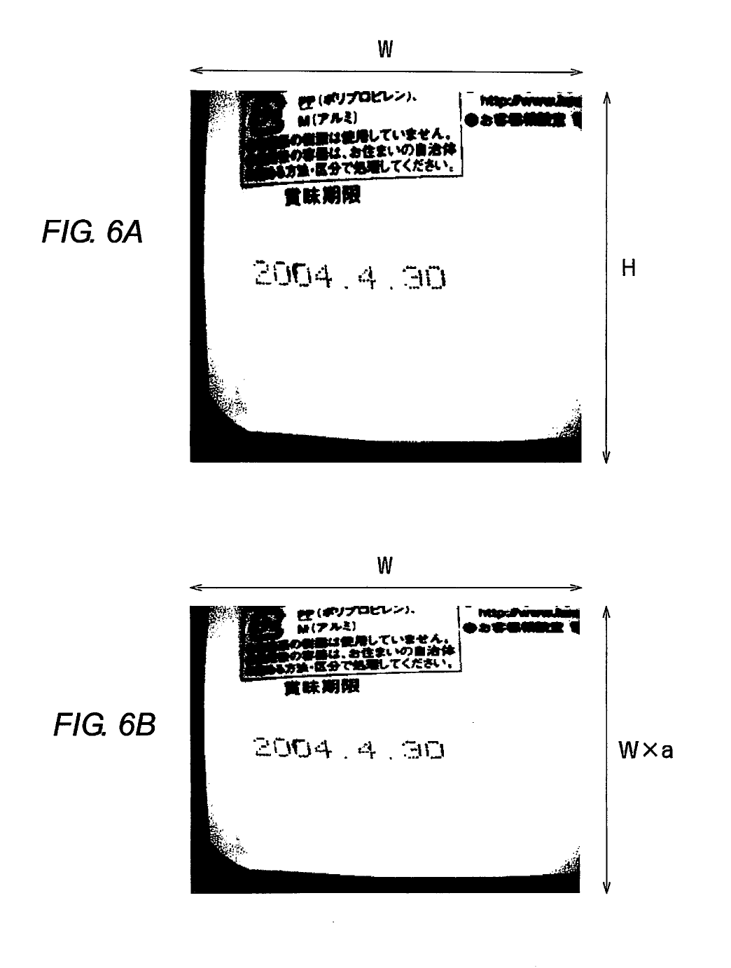

The CPU 11 converts a target image into an image of a letter search format Specifically, the CPU 11 converts the gray scale of the image, and then, converts the aspect ratio thereof as described below. FIGS. 6A and 6B are views showing images before and after the process in step S103 is performed, respectively.

Assume that a target image is an image containing letters to be detected (or an original image) generated by the camera 2 (see FIGS. 1 and 2) and stored in the image memory 14. In addition, the aspect ratio of the target image is assumed to be H:W as shown in FIG. 6A Now, a parameter “a” is used to convert the aspect ratio of the target image as follows:

H:W=a:1 or H/W=a

As a result, the converted image having an aspect ratio of (W×a:W) is acquired as shown in FIG. 6B. This converted image is stored in the image memory 14 independently of the target image.

In this embodiment, a generally known interpolation technique may be applied to the image conversion process. Examples of such an interpolation technique are Bilinear interpolation and Bicubic interpolation. Bilinear interpolation is a technique to linearly interpolate a luminance value at each pixel by using luminance values at four (2×2) pixels arranged around the pixel. Bicubic interpolation is a technique to interpolate a luminance value at each pixel by a three-dimensional equation using luminance values at sixteen (4×4) pixels arranged around the pixel.

Step S104: Searching Letter

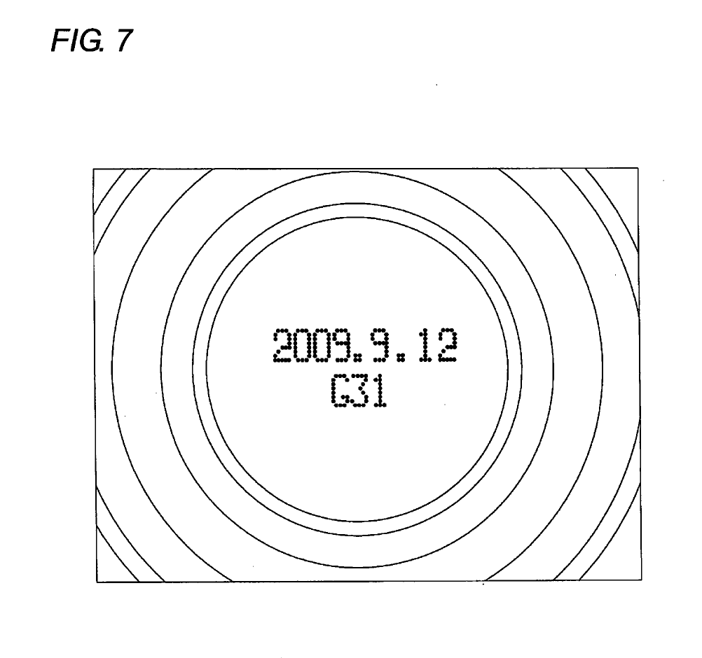

The CPU 11 searches for letters contained in the converted image stored in the image memory 14 by using a classifier generated through a statistical learning system. In other words, the CPU 11 extracts, from the converted image, a region that possibly contains a letter. FIG. 7 is a view showing an exemplary image used for explaining the process in step S104, and FIG. 8 is a view showing a general determination flow performed by a cascade classifier 7 used in the process in step S104.

More specifically, for example, the CPU 11 subjects the image exemplified in FIG. 7 to a letter search process shown in FIG. 8. In this process, the CPU 11 detects letters by using the classifier generated through the boosting learning. Particularly, letters are detected by an AdaBoost-based classifier utilizing the Haar-like feature, and the classifier is of a cascade type. Referring to FIG. 8, the cascade classifier 7 includes five weak classifiers 71 to 75, and these classifiers constitute a cascade structure, thereby forming a single strong classifier as a whole. Such a cascade classifier needs long learning time, but can recognize a single object at a higher speed, because the classifier excludes regions that do not contain objects to be detected at an initial stage in the cascade.

The above letter search process is performed with multiple layers, and different combinations of letter rectangles are assigned to the respective layers. In this embodiment the “letter rectangle” circumscribes a region having the size same as that of a letter sample image. In addition, different numbers of letter rectangles are assigned to the respective layers in FIG. 8. The determination process sequences are also assigned to the layers, and the individual layers are subject to the determination process in accordance with these sequences. In the example of FIG. 8, the layers 1, 2, and 3 are subject to the processes in this order.

Each of the layers is determined whether or not a letter is contained in an interested region by using the assigned letter rectangle patterns, in accordance with the own assigned sequence. If one of the layers is determined that no letter is contained in a certain interested region, then the downstream layers are not determined in this interested region. If the last layer is determined that a letter is contained in the interested region, then the classifier 7 finally determines that this interested region contains a letter in the letter search process.

It should be noted that the structure of a classifier generated through the statistical learning system is not limited to that of the classifier 7 of this embodiment For example, the Neural network structure generated through a learning system employing backpropagation, or the Bayesian classifier, may be applied to the classifier 7.

Step S105: Integrating Search Results

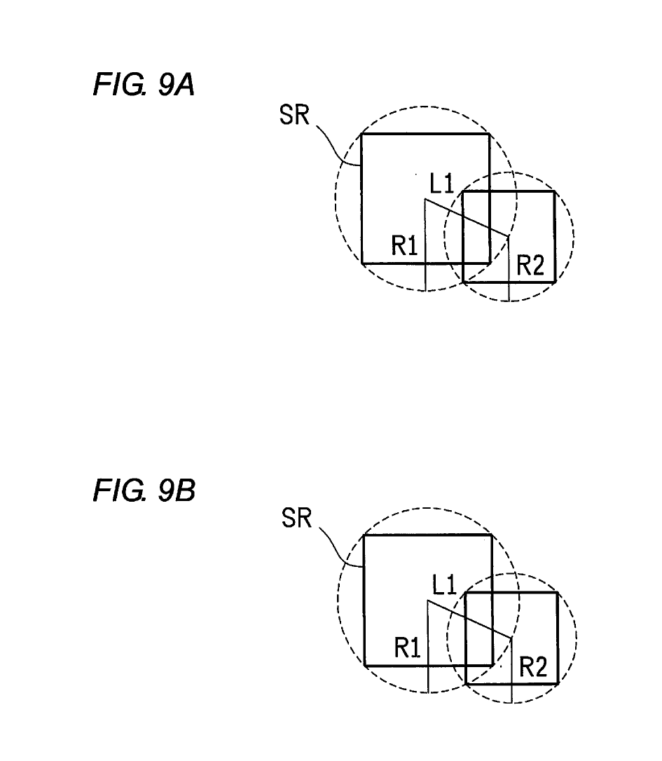

The CPU 11 subjects search results or the letter candidates, which have been determined to contain letters in the search process in step S104, to clustering by using the intersection determination. As a result, these candidates are integrated to a single rectangle. Then, the CPU 11 performs the intersection determination again, thereby eliminating lowly reliable rectangles. FIG. 9A is an exemplary view for explaining the clustering in the intersection determination, and FIG. 9B is a view for explaining the elimination of the rectangles upon the intersection determination.

As to the clustering by using the intersection determination, when the searched rectangles SR are close to each other by a predetermined distance or less, as shown in FIG. 9A, the rectangles SR are classified into the same group. For example, the following equation is given:

(R1+R2)×Threshold<L1

If this equation shows “YES”, then the rectangles SR are categorized into different groups. Otherwise, if the equation shows “NO”, then the rectangles SR are categorized into the same group.

As to the elimination of a rectangle by using the intersection determination, if the rectangles SR are dose to each other by a predetermined distance or less as shown in FIG. 9B, a lowly reliable region is eliminated. For example, a determination equation the same as that applied to the example of FIG. 9A is given again. If this equation shows “YES”, then no process steps are performed. Otherwise, if the equation shows “NO”, lowly reliable regions are eliminated.

Step S106: Returning Aspect Ratio of Integrated Result to Original Ratio

The CPU 11 returns the detected result from the image of which aspect ratio has been converted in the conversion process on the target image in step S103 to an original ratio thereof. More specifically, if the region of the integrated letter candidate has an aspect ratio of h:w, the aspect ratio of the region of this letter candidate is converted by using the parameter “a”, so that a relationship (h/w=1/a) is satisfied. As a result, subsequent processes (a circumscribing process and a mark detection process) can be applied to the original target image. This enables the cutout letter rectangles to be displayed while being overlapped on the target image.

Step S107: Circumscribing Integrated Letter Rectangle

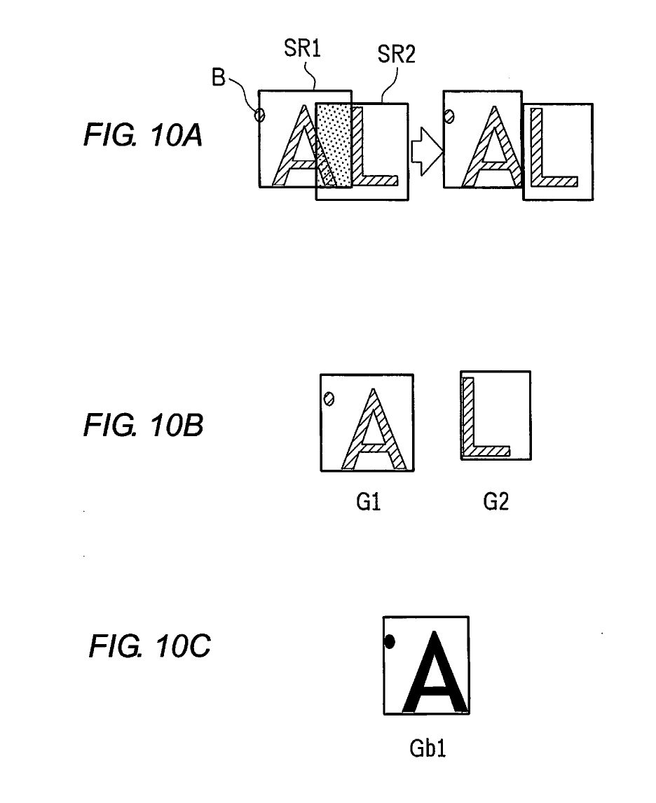

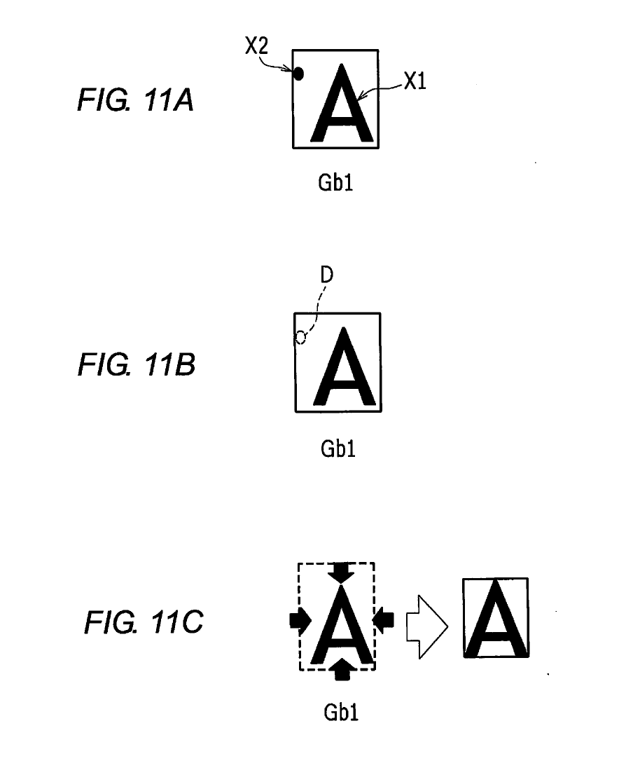

The CPU 11 cuts letters out of the original target image stored in the image memory 14, based on the integrated result of which aspect ratio is returned to an original ratio thereof. Following this, the CPU 11 generates rectangles circumscribing corresponding cutout letters. Specifically, the CPU 11 performs the adjustment of overlapping between the rectangles, the cutout of an image in each rectangle, a binary process, a labeling process, the elimination of noise on the frame of each rectangle, and a fitting process in this order. FIGS. 10A, 10B, and 10C are views for explaining the adjustment of overlapping between the rectangles, the cutout of an image in each rectangle, and the binary process, respectively. FIGS. 11A, 11B, and 11C are views for explaining the labeling process, the elimination of noise on each rectangle frame, and the fitting process, respectively.

For example, as shown in the FIG. 10A on the left, a rectangle SR1 containing a letter “A” and a stain (a dot of the stain) B overlaps a rectangle SR2 containing a letter “L”. In this case, the CPU 11 adjusts the overlapping between both of the rectangles such that the rectangles are separated from each other as shown in FIG. 10A on the right

Next, the CPU 11 cuts images out of the respective rectangles, as shown in FIG. 10B. In this case, the image containing the letter “A” and the stain is called an “image G1”, and the image containing the letter “L” is called an “image G2”.

Subsequently, the CPU 11 subjects the cutout images to a binary process such as the discriminant analysis method or some other known method, thereby acquiring a binary image Gb1 in FIG. 10C, for example.

Following this, the CPU 11 subjects the binary image Gb1 to the labeling process (regionalization). Referring to the example shown in FIG. 11A, a label “X1” is assigned to the region corresponding to the letter “A” in the image Gb1. Similarly, a label “X2” is assigned to the region corresponding to the stain.

Then, if the area of a region on the frame of a rectangle is smaller than a threshold, then the CPU 11 determines that the region is noise, and eliminates this region. Referring to the example shown in FIG. 11B, the region X2 corresponding to a stain becomes a target D to be eliminated, but the region X1 containing the letter “A” does not become the target D to be eliminated and is left as it is.

Finally, the CPU 11 shrinks the rectangle to the labeled position so as to be fitted. Referring to the example shown in FIG. 11C on the left, the rectangle of the image Gb1 is shrunk to the position labeled with the region X1. As a result, the rectangle circumscribes the letter “A”, as shown in FIG. 11C on the right

Step S108: Detecting Mark

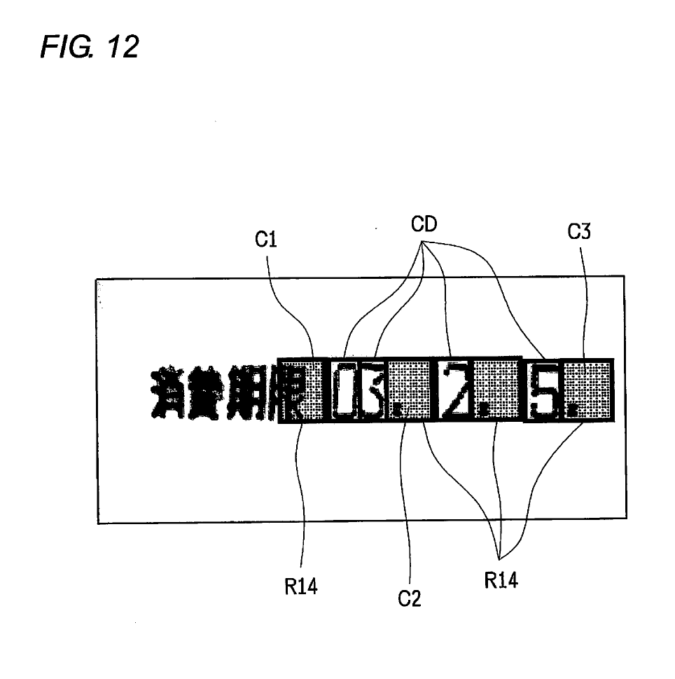

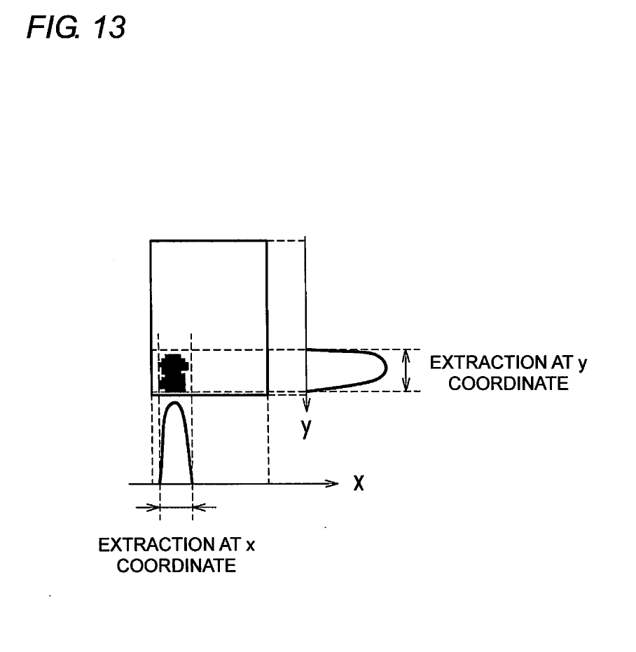

The CPU 11 performs a mark detection process of extracting a region corresponding to a mark by using binary and projection processes. FIG. 12 is a view for explaining the estimation of mark search regions, and FIG. 13 is a view for explaining the detection of a mark by using the binary and projection processes.

As shown in FIG. 12, the CPU 11 estimates mark search regions by using the maximum heights of letter detection results CD. Each mark search region R14 corresponds to a letter string head C1, a letter interval C2, or a letter string end C3. Then, the CPU detects marks by using the binary process and projections in the X and Y directions, as shown in FIG. 13.

This mark detection (step S108) is applied to the original target image stored in the image memory 14, based on the integrated result of which aspect ratio is returned to an original ratio thereof, similarly to the process of circumscribing the integrated rectangle (step S107). Since the converted image is not a process target, unlike the letter search process in step S104, any affection, such as misshape of a mark caused by the aspect conversion process or the like, can be prevented.

<User Interface Screen>

FIG. 14 is a view showing an example of a user interface screen 30 displayed on the monitor 3. This screen enables a user to enter, with the input device 4, a predetermined ratio defining the aspect ratio of a target image in the image compression unit 111.

As shown in FIG. 14, the user interface screen 30 includes an input image display unit 31, a result display unit 32, an image input button 33, an aspect ratio input unit 34, a letter color input unit 35, a rotation angle input unit 36, and a process region setting button 37. Specifically, the input image display unit 31 is placed at the upper left portion of the user interface screen 30, and displays an input image. The result display unit 32 is placed below the input image display unit 31 and at the lower left portion of the user interface screen 30, to display the result of letter detection. The image input button 33 is placed at the uppermost right portion of the user interface screen 30, and is used to trigger the inputting of an image. The aspect ratio input unit 34 is placed below the image input button 33, and enables the inputting of a predetermined ratio defining the aspect ratio of the target image. The letter color input unit 35 is placed below the aspect ratio input unit 34, and enables the setting of the colors of letters. The rotation angle input unit 36 is placed below the letter color input unit 35, and enables the inputting of the rotation angle of letters. The process region setting button 37 is placed below the rotation angle input unit 36.

The aspect ratio input unit 34 may be, for example, a scroll bar used for entering an aspect ratio within a range of 1:10 to 10:1.

The letter color input unit 35 is used to recognize letters of various colors at a high speed, and may include, for example, radio buttons.

The rotation angle input unit 36 is used to easily recognize angled letters by rotating an image.

The process region setting button 37 is used to limit (by operating a touch panel, a coordinate input unit, or the like) a process region, thereby making the process faster or excluding non-target letters for recognition.

It should be noted that the image input button 33, the letter color input unit 35, the rotation angle input unit 36, and the process region setting button 37 may be optional, and these units may not be provided.

The invention can be implemented in various modes without departing from the spirit and essential features of the invention. Therefore, the above-described embodiment is simply an example in every way, and should not be considered as a limitation. The invention is defined by the claims and is not restricted by the specification. Furthermore, any modifications and variations to the invention within the scope of equivalents of the claims can be considered to fall within the invention.

The invention is applicable to an image processing device, an image processing method, and an image processing program for detecting a letter or the like.

What is claimed is:

1. An image processing device for detecting a letter by using a classifier generated through statistical learning of handling a sample image of a fixed size as supervised data, the image processing device comprising:
a conversion unit configured to acquire a converted image by geometrically converting a target image containing a letter to be detected such that the target image has a predetermined ratio defining an aspect ratio;
a search unit configured to search the converted image for one or more letter candidates each including a region of a possible letter by using the classifier;
an integration unit configured to apply clustering to the letter candidates searched for by the search unit, integrate the letter candidates, and eliminate the letter candidate having low reliability; and
a circumscribing unit configured to cut a letter out of the letter candidate that has been integrated and has not been eliminated by the integration unit, and generate a rectangle circumscribing the letter.

2. The image processing device according to claim 1, further comprising a setting input unit configured to receive an external setting input of the predetermined ratio defining the aspect ratio of the target image by the conversion unit.

3. The image processing device according to claim 1, further comprising a second conversion unit configured to convert an aspect ratio of the regions of the letter candidates by using a reciprocal ratio of the predetermined ratio.

4. The image processing device according to claim 2, further comprising a second conversion unit configured to convert an aspect ratio of the regions of the letter candidates by using a reciprocal ratio of the predetermined ratio.

5. The image processing device according to claim 3, further comprising a mark detection unit configured to extract a region corresponding to a mark from a non-letter region circumscribed in a rectangle generated by the circumscribing unit.

6. The image processing device according to claim 4, further comprising a mark detection unit configured to extract a region corresponding to a mark from a non-letter region circumscribed in a rectangle generated by the circumscribing unit.

7. The image processing device according to claim 1, further comprising a letter recognition unit configured to recognize the letter circumscribed in the rectangle generated by the circumscribing unit

8. The image processing device according to claim 2, further comprising a letter recognition unit configured to recognize the letter circumscribed in the rectangle generated by the circumscribing unit

9. An image processing device for detecting a letter by using a classifier generated through statistical learning of handling a sample image of a fixed size as supervised data, the image processing device comprising:
a conversion unit configured to geometrically convert an acquired target image to a converted image, the target image containing a letter to be detected such that a parameter indicating a geometrical feature of the target image has a predetermined value; and
a search unit configured to search the converted image acquired by the conversion unit for one or more letter candidates each including a region of a possible letter by using the classifier.

10. The processing device according to claim 9, wherein the parameter includes an aspect ratio of the target image.

11. The processing device according to claim 9, further comprising an integration unit configured to apply clustering to the letter candidates searched for by the search unit, integrate the letter candidates, and eliminate the letter candidate having low reliability.

12. The processing device according to claim 10, further comprising an integration unit configured to apply clustering to the letter candidates searched for by the search unit, integrate the letter candidates, and eliminate the letter candidate having low reliability.

13. The processing device according to claim 11, further comprising a circumscribing unit configured to cut a letter out of the letter candidate that has been integrated and has not been eliminated by the integration unit, and to generate a rectangle circumscribing the letter.

14. The processing device according to claim 12, further comprising a circumscribing unit cutting a letter out of the letter candidate that has been integrated and has not been eliminated by the integration unit, and generating a rectangle circumscribing the letter.

15. An image processing method for detecting a letter by using a classifier generated through statistical learning of handling a sample image of a fixed size as supervised data, the image processing method comprising:
a conversion step of acquiring a converted image by geometrically converting a target image containing a letter to be detected such that the target image has a predetermined ratio defining an aspect ratio;
a search step of searching the converted image for one or more letter candidates each including a region of a possible letter by using the classifier,
an integration step of applying clustering to the letter candidates searched for in the search step, integrating the letter candidates, and eliminating the letter candidate having a low reliability; and
a circumscribing step of cutting a letter out of the letter candidate that has been integrated and has not been eliminated in the integration step, and generating a rectangle circumscribing the letter.

16. An image processing computer program operable to cause a computer to execute an image processing method comprising:
acquiring a converted image by geometrically converting a target image containing a letter to be detected such that the target image has a predetermined ratio defining an aspect ratio;
searching the converted image for one or more letter candidates each including a region of a possible letter by using the classifier,
applying clustering to the letter candidates searched for in the searching step, integrating the letter candidates, and eliminating the letter candidate having a low reliability; and
cutting a letter out of the letter candidate that has been integrated and has not been eliminated in the integration step, and generating a rectangle circumscribing the letter.
